(19) United States
(12) Patent Application Publication
(10) Pub. No.: US 2025/0276202 A1
(43) Pub. Date: Sep. 4, 2025

(54) Smart Respirator Mask Air Foil

(71) Applicant: Daniel Dumitru Dorneanu, Charleston, SC (US)

(72) Inventor: Daniel Dumitru Dorneanu, Charleston, SC (US)

(21) Appl. No.: 18/593,895

(22) Filed: Mar. 2, 2024

(51) Int. Cl. A62B 18/08; F21V 33/00; F21Y 115/10

(52) U.S. Cl. CPC A62B 18/08; F21V 33/0064; F21Y 2115/10

(57) ABSTRACT

SPF (spray polyurethane foam) insulation applied in a commercial or residential building is an amazing but costly construction product. One reason is that application of SPF insulation creates overspray media in large concentrations, adhering to the operator and all equipment present in the spray area. The media buildup is detrimental to equipment, especially when it deposits onto the operator's respirator visor, obstructing his vision and contributing to increased glare. This results in increased safety risks of trip and fall accidents, reduction in the work quality and reduced job performance. We worked to solve this problem by designing, building, and testing an air foil device called Q-Flow which uses pressurized air/gas to deflect the overspray media, and reduce the overall media quantity which adheres to the visor in the light of sight. Q-Flow can also make use of a directed light helping the operator to perform work in low light environments.

This application claims the benefit of U.S. Application No. 63/488,092 filed Mar. 2, 2023 titled Smart Spray Foam Respirator Air Foil, and the benefit of U.S. Application No. 63/503,726 filed May 23, 2023 titled Smart Respirator Mask Universal Air Foil. The contents of which are hereby incorporated by reference.

### TECHNICAL FIELD

Polyurethane Spray Foam Insulation

### BACKGROUND

In our spray foam insulation company, we often work in extreme environments (130 F-150 F with lighting and limited breathing oxygen) and often 100-300 feet away from the spray rig (which contains all equipment and chemicals needed for the application) FIG. 1. The SPF is applied to substrates at high pressure using a spray gun by a qualified installer wearing the proper PPE (personal protection equipment) including a workplace FFBA (Full Face Breathing Apparatus) such as a respirator, hood, or helmet, FIG. 3. Throughout the Specification the words Respirator and FFBA are used interchangeably. During the application, especially when applying overhead, spray foam airborne media re-directs toward the applicator and attaches to his/her spray suit and visor. As more and more medias attach to the visor, the vision of applicator is reduced, resulting in increased safety risks, poorer application quality and reduced performance.

Various types of respirator masks may be equipped with various types of transparent face visors and/or eye shields. The proper sight of the worker is essential to be able to identify work area characteristics, proper function of the equipment output (like spray consistency) and/or potential safety hazards etc. The FFBA functions in environments such as applying spray foam, paint, powder coating, etc, which can cause buildup of debris and contaminate the transparent field of view of the workers and/or sensors. Typically, the visor and/or sensors may be protected with a spray-on fluid or clear cover to reduce the adhesion of such debris and contaminants: but over time, the protective fluid becomes ineffective, after wiping away the debris. As such, the visibility of the worker and/or the function of the sensors may be impeded as the debris is starting to block the field of view necessary to be productive or to achieve the proper signals of sensor.

When performing work functions with use of a respirator, conditions are often encountered where lighting is not optimum. Working in crawlspaces, attics for example, even with the use of portable shop lights, the operator finds themselves in locations and situations where additional lighting is beneficial. For this function, respirator operators make use of headlamps which normally attach on the outside of the respirator using an elastic headband. While such a “camping” headlamp does help, the elastic band interferes with the respirator seal compression, to a certain extent. “Camping” headlamps are also designed to fit onto the user's forehead which is typically perpendicular to the line of sight. When installing such a headlamp onto a respirator, due to the respirator visor being sloped, the light tends to beam in the upward direction and not where it is needed. Other negative effects of using a typical headlamp with a respirator are that the headlamp will have a high profile where there is risk of snagging or catching on obstacles. The present invention relates to the field of respiratory masks, more particularly, a laminar flow device that functions with a respirator mask for improving the efficiency of visor shields used in the field were contaminants are created and can settle onto the shield surface.

Respiratory masks have become a common means of protecting against chemicals in the workplace. However, the traditional designs of masks are known to become covered to a high degree of usage during the spray foam overhead application. Therefore, a need exists for providing a device that can protect the visibility of the spray foam applicator.

### INDEX OF ACRONYMS

FFBA—full face breathing apparatus such as a respirator, hood or helmet.
U2—universal design air foil utilizing the shield method.
U3—universal design air foil utilizing the curtain method.
Ud—universal design air foil with integrated HUD
Li—design with internal light
U3s—universal design air foil with light, and electrostatic function
FIL—Feature Identification Lighting
ACM—Air Curtain Method
ASM—Air Shield Method
SID—Seal Integrity Detection
RADS—release agent dispensing system
COB—chips on board
COM—Intercom system with throat mic and ear piece
LCN—low charge notification
FFF—form, fit, function.
PPE—personal protection equipment
SPF—spray polyurethane foam
HUD—heads up display.
LOP—lighting overspray protection.
ALD—angular lighting direction
WPS—wireless power source
MAP—manifold air pressure.
TTI—tell-tale indicator.
LTM—laser temperature measurement.
ESC—electrostatic charge.
ODE—overall deterrence efficiency.
PNP—particle neutralization process.
MLD—managed light diminishing.
IPC—intelligent pneumatic control
PCB—printed circuit board

### PRIOR ART

On the market today, to my knowledge there is not a system that reduces or prevents material overspray from contacting the respirator visor during spray applications. On the market today, to my knowledge there is not a directed light module designed specifically for workplace respirators, and certainly not without impact to form fit or function of the respirator.

### SUMMARY OF THE INVENTION

We have designed, built, and tested a device (called Q-Flow) which functions with an FFBA such as a respirator (FIG. 4), hood (FIG. 13) or helmet (FIG. 14) and dispenses a directed air flow in front of the respirator visor with the purpose of diverting overspray generated during work, with goal that the overspray does not contact the visor. Other parts of the respirator such as the exhalation valve, LED lights and cartridges can also be “protected” when concentrated air flow is directed in those corresponding areas. Q-Flow can be explained into two (2) main categories: a custom design, FIG. 11, where the device is integrated into the respirator design of a limited number of designs, and shares commonality with another integrated component, such as the exterior bezel or a protective cover. The second (U2 or U3) is standard in its primary design function and designed where one version is intended for unlimited number of respirator designs, FIG. 20. The universal design allows for installation on most respirator visors, where the visor contour shape is utilized to allow the U2/U3 to have a sleek and low-profile. Q-Flow has one or more ports allowing compressed air or other gas to enter, which then dispenses through passages in the intended direction. Q-Flow has other options for additional functionality such as internal LEDs, and a MAP sensor with tell-tale indicator, TTD. Another option is the HUD (Heads Up Display,) which can display data from the rig, can show sprayers body vitals (from data received from sensors attached to the person's body) and can show respirator performance data. Q-Flow has an option for integrated RADS (release agent dispensing system.) Lastly, Q-Flow has a sister version called Li (FIG. 27.) Li has additional features which make it a light specifically intended for use with a workplace respirator: a safety-oriented glow in dark feature, and a colored LED and diffusion designed to accentuate the features important to the user in their specific work application. We call this Feature Identification Lighting (FIL.) For example, in SPF applications being able to accentuate low SPF depth areas more easily to allow for touch-up more quickly than without its aid. FIGS. 22 and 23. Studies have shown an 80%-time reduction relating to this feature. While time is important and adds up over the course of a day, where several hundred “touch-up” actions take place, the focus strain and consequent user energy exhaustion is equally valuable. In some cases, the same color and diffusion LED lends itself to other enhancements, such as in the case of a green LED. Green LEDs are known for allowing a user to see a longer distance, using less heat, using less power, creating a lower glare, and less risky to “blinding” a fellow worker when shining the light toward him/her. As with the universal design, the Li has multiple optional features, such the face seal detection and a system allowing for the user to not be “caught off-guard” when battery is running low, called MLD (managed light diminishing.) For example, at 15% battery life the system switches to red LED's only, thereby informing the user of the low battery level and still providing supplement lighting for the work task. The user will thus be aware that only 1 hour remains using the low-level lighting, however he is not “caught off-guard.”

The Li is typically designed to fit inside the respirator visor. This allows for the Li to stay clean of overspray during work. The Li design is typically a convex shape matching the visor inside curvature. It is important to note that Li, similar to Q-Flow can be designed as an integrated component of the FFBA (performing other functionality, such as the respirator bezel) FIG. 7, or can be a universal design which can be fitted to unlimited number of FFBA designs. In the universal version, the form, fit and function of the FFBA is not impacted. In the Li universal design, a cable to an external power supply such as an external battery cannot be used without impacting the form, fit, function of the respirator. An alternative solution is with use of wireless charging technology where a wireless “transmitter” coil (WPS) is located on the inside of the visor and the wireless charger coil is located on the outside of the visor, FIG. 9. Charging of the internal battery or full powering of the Li can thus be achieved through the visor plastic.

The present invention, a laminar flow device, is an integrated device or an attachment that can be directly fixed on top of any common respirator without requiring any adaptation. In this invention, a laminar flow path is created using specialized airflow channels that range across the entire shield of the mask. This produces a uniform flow of air with controlled speed, which results in improving the visibility of the mask by diverting particles away from the visor. The laminar flow device consists of a body, which is an airtight attachment to the mask shield. The body of the device is a combination of a housing plenum and airflow channels. In the universal design, the housing plenum is designed to accommodate the attachment to the mask, and airflow channels are incorporated to allow for the enhanced laminar flow.

The airflow channels are reinforced with multiple built-in diverters that aid in the streamlining of airflow, to ensure uniform laminar flow. The present invention is a unique design as it provides an effective solution to improve the efficacy of respiratory mask visibility, for all respirator designs. Turning to the measurement of effectiveness, we will refer to this as an “overall deterrence efficiency, ODE.” The ODE is measured in percent 0-100% where 0 has no effect on the overspray, and 100 has full deterrence effect on the overspray for a chosen testing media. When comparing field results with and without the use of Q-Flow, there is a significant improvement shown, as can be seen in FIGS. 12 (with) and 13 (without). We assign an ODE of 70% with the Q-Flow and 0% without Q-Flow. During testing, we discovered that further “neutralizing” of the overspray can take place where even the particles which penetrate the ACM and/or ASM will have a reduced adherence to the visor in comparison to their normal adherence without the use of Q-Flow. This is achieved not only by reducing the velocity at impact with visor but also where the air-knife changes the composition of the particles. We call this particle neutralization process, PNP.

### BRIEF DESCRIPTION OF DRAWINGS

FIG. 1 shows typical main components of a spray foam rig.

FIG. 2 shows a U2 module.

FIG. 3 shows a sprayer applying SPF to a substrate.

FIG. 4 shows a respirator with air foil and WPS.

FIG. 5 shows an internal design of the plenum cavity.

FIG. 6 shows an intercom system.

FIG. 7 shows a Q-Flow custom design.

FIG. 8 shows a typical Ui module.

FIG. 9 shows a typical configuration of wireless power for a Q-Flow or Fi module.

FIG. 10 shows the location for the wireless coil embedded design.

FIG. 11 shows a respirator with a Q-Flow custom design and optional HUD.

FIG. 12 shows the Static Electricity diagram for basis of ESC.

FIG. 13 shows a diagram of hood as an FFBA.

FIG. 14 shows a diagram of helmet as an FFBA.

FIG. 15 shows the diagram of the ESC functionality.

FIG. 16 shows a U3 module.

FIG. 20 shows a respirator as an FFBA with an attached U2 module.

FIG. 21 shows an embodiment of the HUD system functionality.

FIGS. 22 and 23 show examples of FIL for SPF on and off to accentuate low depth (valleys) conditions.

FIGS. 24 and 25 show a field result using Q-Flow versus similar field result without the use of Q-Flow.

FIG. 26 shows a Weather Alert Notification which can be sent to the HUD using the Ud application.

FIG. 27 shows a Li universal installed inside a respirator.

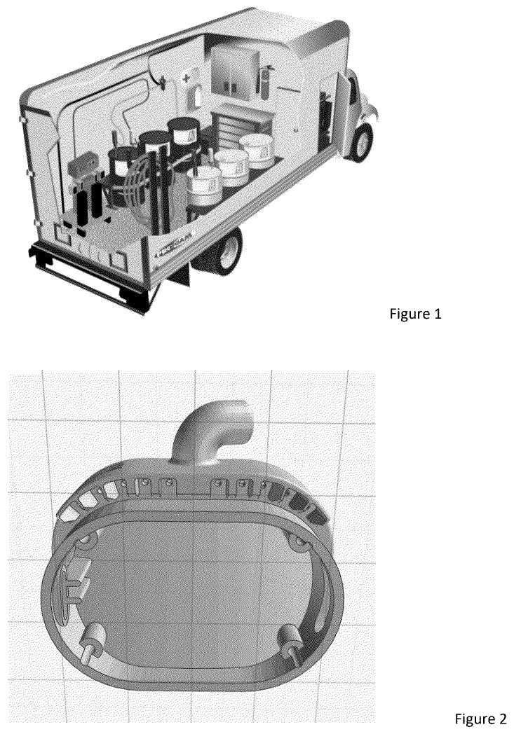

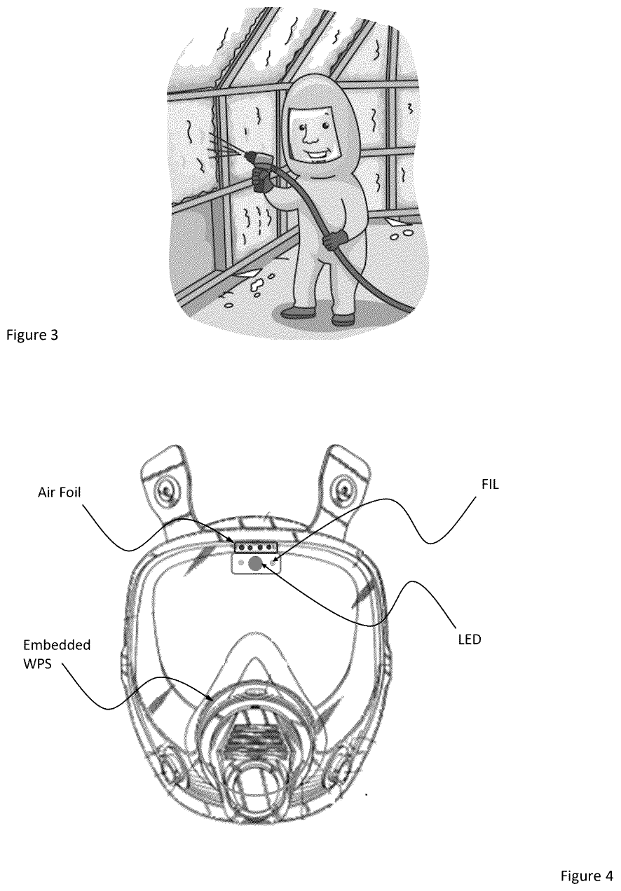

### DETAILED DESCRIPTION OF INVENTION

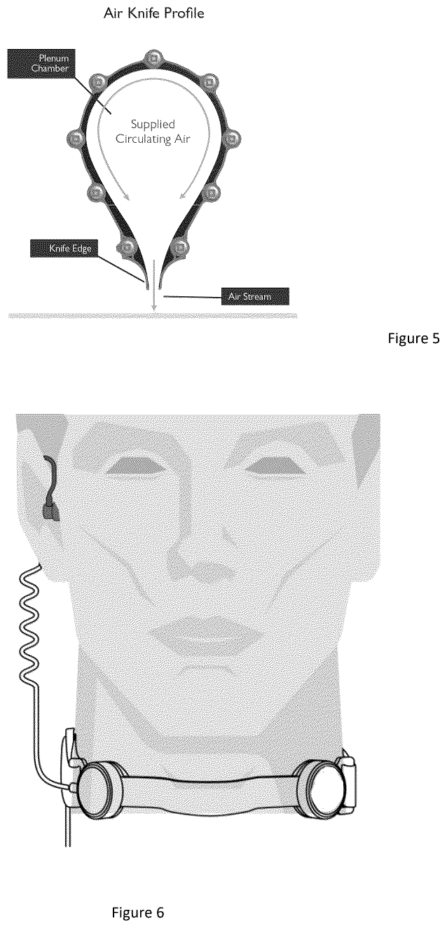

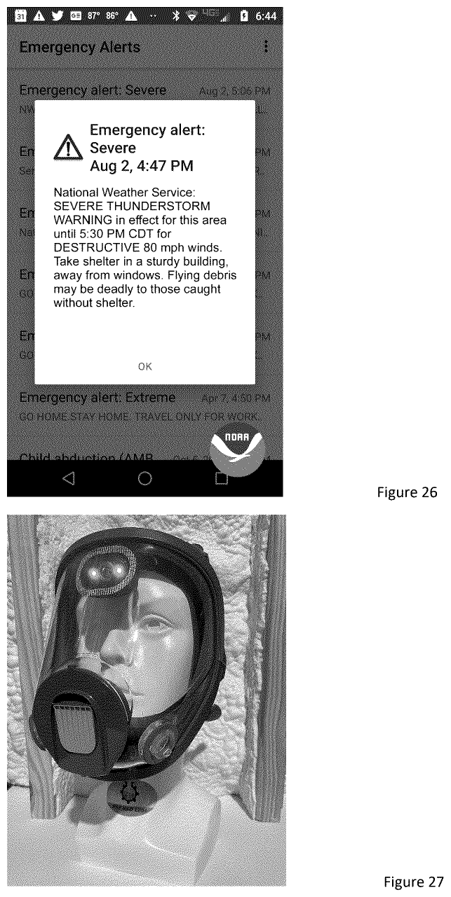

The Q-Flow unit consists of the main body with integrated air-knife, port(s) for one or more air fittings, plenum channel and air flow channels. Flow velocity and direction optimizing performance is achieved through the design of the plenum and directional channels, blades on the interior and exterior of the body. Additional options include LED lighting directed toward the work surface, with an internal or external power source. Additional options include a MAP (manifold air pressure) sensor with a circuit to read the input from the sensor and trigger the tell-tale based on set parameters. Similar safety functionality can be achieved with other sensors such as flow sensors, chemical sensors, with the intended purpose of aiding the user in determining if his/her respirator is functioning as intended (proper seal, protection from hazardous chemicals, etc.) We call this SID (Seal Integrity Detection.) Similar functionality can be achieved with a power source directly from the spray rig without the need for a battery. The HUD option attached to the Q-Flow provides data to the user coming from the rig, from the sprayer vitals sensors, and/or the Q-Flow sensor(s). In the universal design, the HUD is located within the Q-Flow U3 cavity. The display engine and electronics can be integral to the Q-Flow U3 main body or plug into the main body for functionality with the Display module. The display can be of multiple designs such as a simple micro-OLED with optional mirrors and lenses, a waveguide which also can use a micro-OLED, or a MEMS laser directed toward the user eye retina. The data to be displayed onto the HUD can be as simple as a Bluetooth chip and processor which reads data coming from a portable device, such as a cellular phone running a mobile application. In such an embodiment, the hardware cost is minimized to where the affordability allows for easy user adoption. The mobile application running on the portable device can directly communicate with the peripheral equipment from which to receive data from, such as proportioner pressures, temperatures, volumes, flow rates. However, the application can be as simple as a repeater of an existing display. In other words, similar to how a text-to-speech application reads a screen of information and repeats the information over audio, the Ud application reads the screen information and repeats the information to the HUD. i.e. Pressure A=1200 psi. FIG. 21. In one embodiment, the HUD upgrade option in addition to an existing U3 system is a cost addition of less than $50. Prior to this invention, having live data inside the user respirator was 20× to 40× more expensive, making the technology unreachable for most users. With this invention, users working in an environment where access to data is extremely valuable, now have this option within their reach. Speaking a little bit outside the box, as an inventor I have always taken the most pride in possibly lesser impact inventions which can benefit more people, than higher impact inventions which only a limited few will likely benefit from. In one embodiment, the Ud application reads and interprets information from the user interface of other applications running on the portable computer, and as an example, interprets a “weather alert” as an important notification to pass onto the user, who may be working in the attic of a house. The notification (FIG. 26) alerts the user that he may want to stop work temporarily if a tornado is in the area. The device may also have an intercom system (COM) integrated within the cavity or connected using a cable. The intercom systems allows for communication with other workers in the area using a throat microphone and an ear piece, FIG. 6. The throat microphone allows for communication in a noisy environment such as SPF application, whereby the earpiece allows for text to speech functionality where the Ud application “speaks” the screen data to the user.

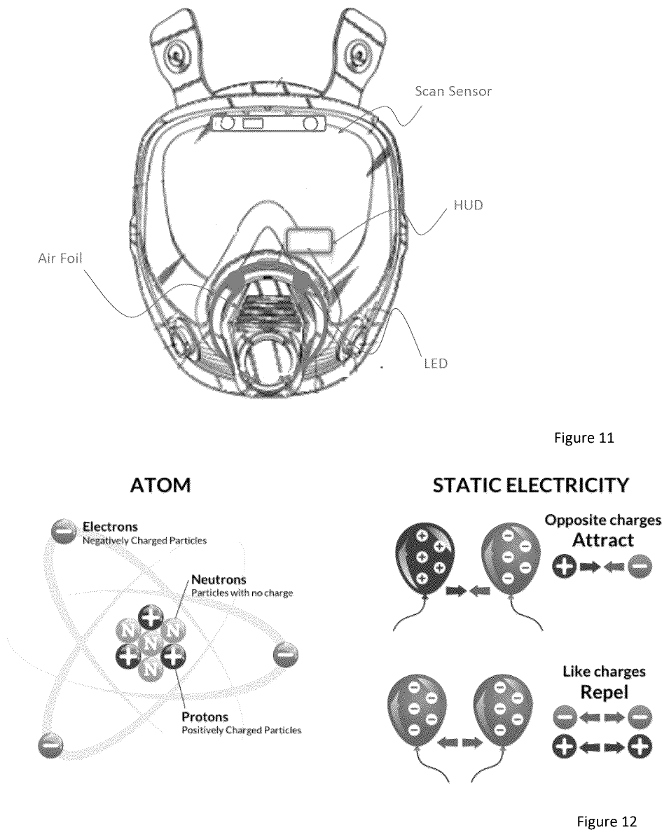

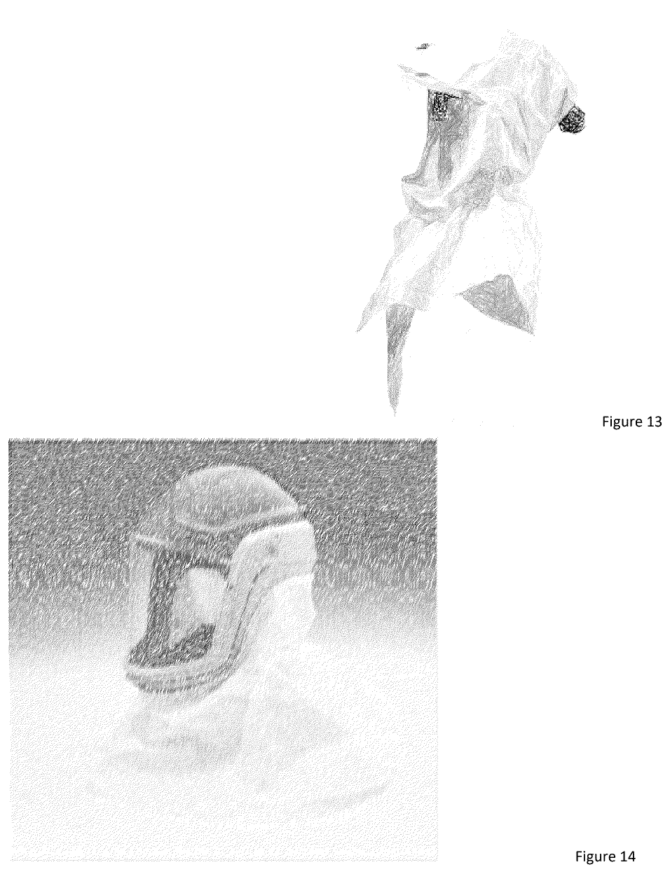

This technology generally relates to a device for clearing the field of view of the visor and/or sensor(s) area of respirator mask and improving the visibility for the user. The device is typically an integrated component of the respirator or is secured to the respirator via a clip and at least one attached feature of the respirator mask, such as the bezel. In some embodiments it is secured to the respirator mask by stick-on feature, such as strong double sided round adhesive “coin.” The device may comprise one or more air foils which attach to a respirator mask and dispense directed air/gas to area(s) of field of view needed for the worker and/or sensor(s). The air foil(s) may be configured in such a way to clear the field of view(s) of the visor and/or sensors of particles or contaminates from overspray reaching the visor and/or sensor(s) by providing a pressurized foil of air/gas in an appropriate angle in front of the visor and/or sensor(s). The purpose of the air/gas flow is to divert particles or contaminates from overspray generated by the task performed to contact the protected field of view of the visor and/or sensor(s). The device can include at least one plenum integrated which allows the supplied air/gas to be channeled to the air foil slots. In some embodiments the system may include at least one additional channel. In some embodiments the system may include one or more air foils which may be configured to clear other essential parts of the respirator such as the exhalation valve, lights, sensors, and cartridges by the same principle. In some embodiments the system may include one or more ports allowing the compressed air/gas to enter the plenum(s). As previously detailed, in some embodiments the system may include a MAP sensor, wherein the MAP sensor in some instances is configured to detect the change of pressure/vacuum within the respirator to alert the worker of a potential safety hazard (SID.) The proper seal can also be detected using other methods than pressure, such as monitoring exhalation flow, or a combination of pressure measurements and/or flow measurements. Some methods may also “learn” the specific measurements for that user configuration first and using this data perform the proper calculations that results in a pass/fail SID and notified the user through the TTI. The TTI can utilize the existing LEDs also used for lighting (such as a flashing method) or a separate LED facing the user. In some embodiments the device may include an integrated laser temperature measurement (LTM) component and optional feedback data on the optional HUD. This can be useful to check substrate temperature easily, to check chemical fluid temperature, and exothermic reaction temperature. In some embodiments the device may include a charging port to allow for charging of the internal energy source. In the Li design, when the light is internal to the respirator, a cable to an external power supply such as an external battery cannot be used without impacting the form, fit, function of the respirator. An alternative solution, when the device is external to the visor, is with use of wireless charging technology (WPS), FIG. 11, where a wireless “transmitter” coil is located on the inside of the visor and the wireless charger coil is located on the outside of the visor, typically in a location where the vision of the user is not obscured such as close to the nose mask and around lower face-cheek area. Charging of the internal battery of the Li or powering of the Li where an internal battery is not used can thus be achieved through the visor plastic, as in the process of charging a cellular phone through the phone case plastic. The charger module on the exterior of the visor can be “fixed” to the proper location aligning to the interior module using magnets. The integrated Q-Flow can also incorporate the WPS system where the circular charger coil can be embedded within the sometimes-round Q-Flow cavity, FIG. 10 allowing for a seamless design and achieving its objective of providing power to a component inside the visor, such as an LED. We call this “embedded WPS”. Similar process In the Li design, in some rare instances when alteration of the form, fit and function of the respirator is allowed (through testing and certification,) and one of the respirator cartridge ports is not used, a possibility exists to use this attachment point to locate an external battery holder and thus allow for the cable to be routed to the interior Li module for charging of internal battery. This same port can also house a sensor. Q-Flow also has an option for integrated RADS (release agent dispensing system.) The foam release agent is typically applied to the visor using an aerosol spray-can by the user. In many cases, ingredients of the release agent are harmful to the user. As such, directing an aerosol can at the visor in a work environment, even when wearing the respirator (with breathing protection) 30 times per day on average for 3 seconds of spraying is not a safe practice. Unfortunately, it is a common risk in the SPF industry. As such, allowing RADS to dispense the foam release agent in a controlled and repeatable process, significantly reduces the risk of foam release bypassing the mask seal or finding other entry points into the respirator, making its way into the operator breathing system. RADS dispenses the foam release onto the visor in a non-perpendicular direction (such as the operator typically follows.) Thus, the agent is more effectively used for the intended purpose of coating the visor field of view areas and less is directed toward the face seal, cartridges, operator forehead, neck, etc.

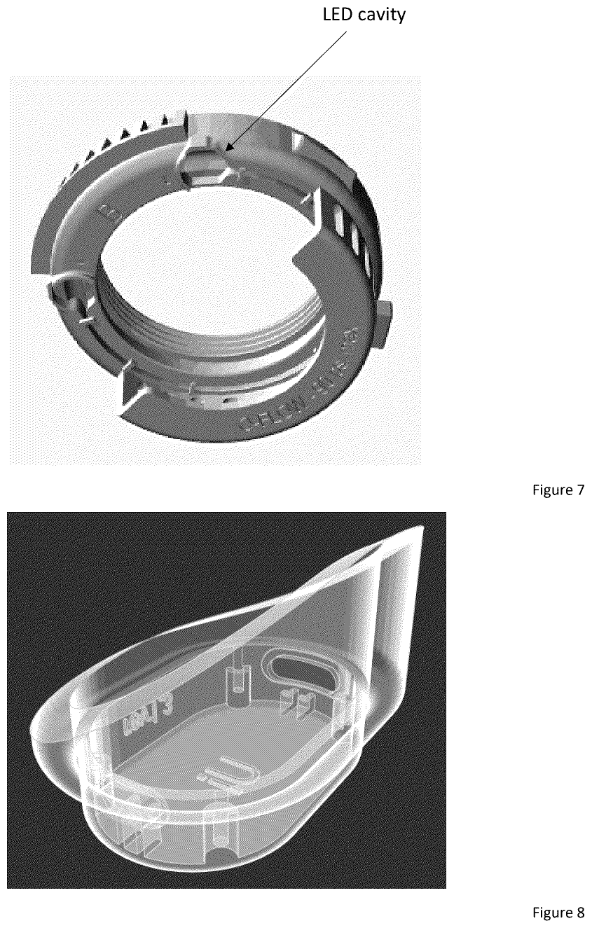

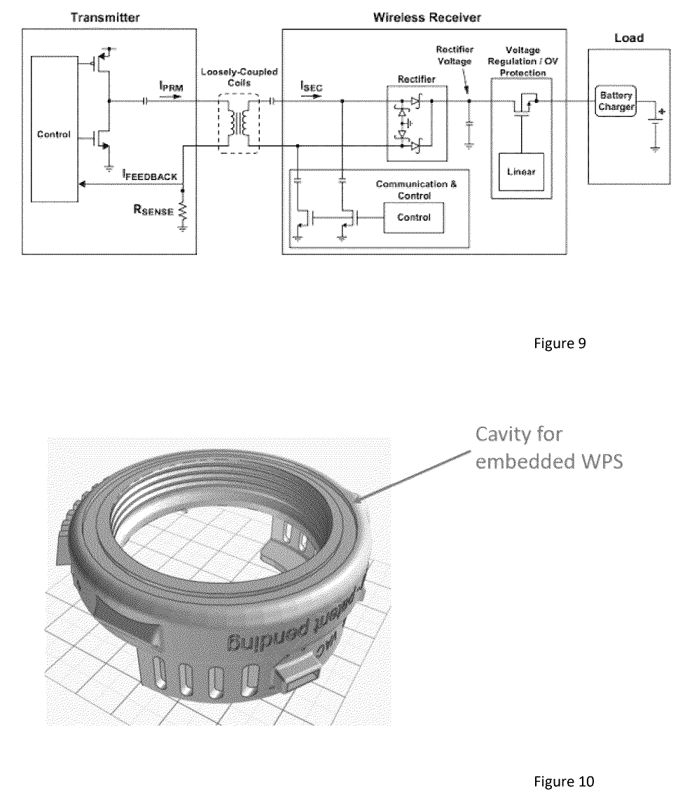

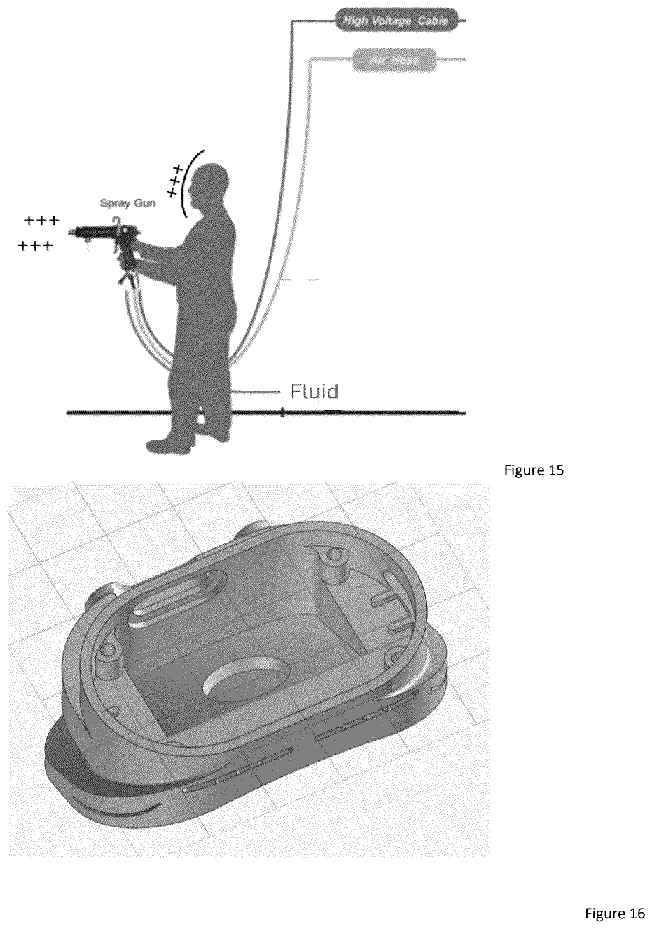

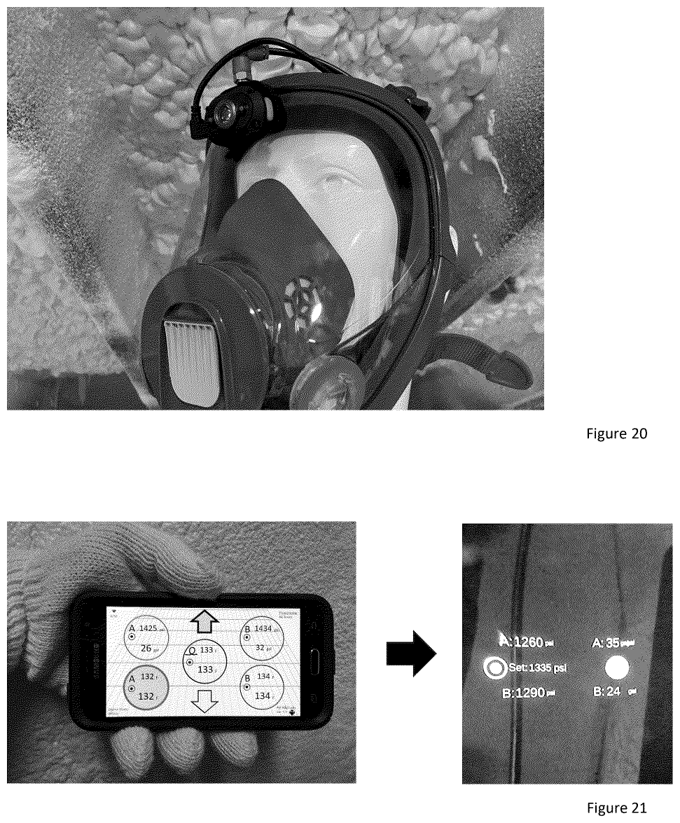

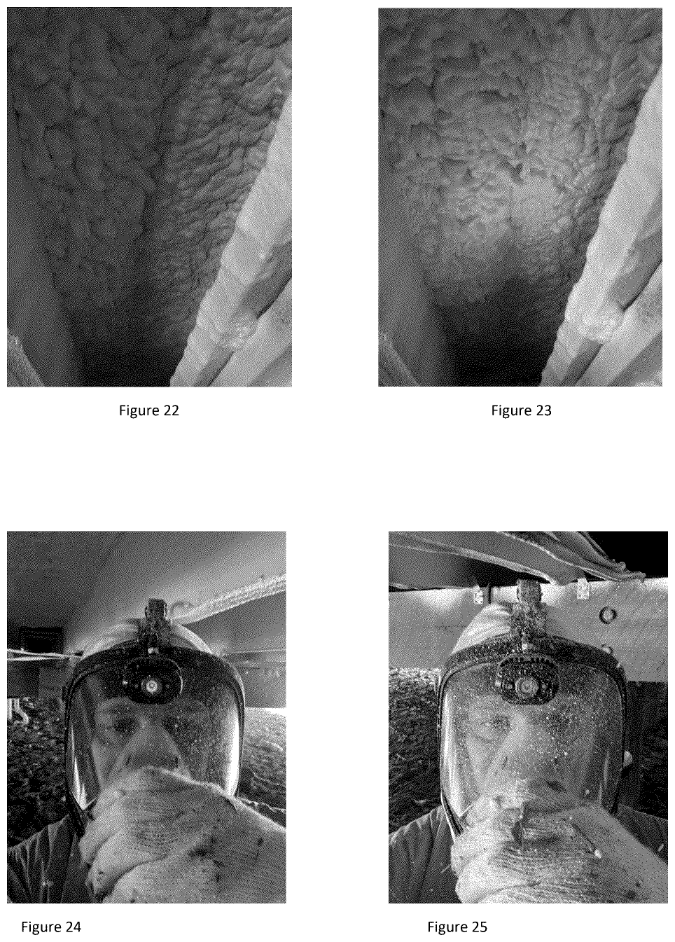

In some embodiments the device may include at least one cavity to allow the integration of electrical conductors to allow the sensor signals to be transferred to an integrated adapter. In some embodiments, the Q-Flow and Li make use of a colored LED and diffusion designed to accentuate the features important to the user in their specific work application. For example, in SPF applications being able to accentuate low SPF depth areas more easily to allow for touch-up more quickly than without its aid, FIGS. 7 and 8. In some embodiments, the Li shell is coated with glow in dark paint to facilitate locating of respirator in low light conditions. In some embodiments, the Li also makes use of a system for the lighting to step down to conservative setting to preserve battery life when a specific battery level is reached. For example, at 15% battery life the system switches to red LED's only, thereby informing the user of the low battery level and still providing supplement lighting for the work task. The user will thus be aware that only 1 hour remains using the low-level lighting, however he is not “caught off-guard.” We call this Low Charge Notification, LCN. Turning to an enhanced version of Q-Flow, we explore the science of electrostatically charging the air emitted by the airfoil with the intended purpose of creating the same polarity particles in the overspray as the user's visor, FIG. 15. “We have all experienced static electricity. It's the invisible force that makes our hair stand on end or our clothes cling to us. While merely a nuisance in these instances, static electricity can also damage electronics and cause deadly explosions. This is especially true in industrial settings, where common industrial processes such as filling and mixing can create massive static charges and extremely hazardous conditions. To safeguard both persons and property, it is crucial to adhere to applicable safety standards and procedures. Every object is made of atoms that are typically electrically neutral. They contain an equal number of protons (positive charge) within their nucleus and electrons (negative charge) surrounding the nucleus. Static electricity occurs when there is a separation of positive and negative charges within or on the surface of a material or between materials. Electrons may move from one object to another, leaving one object with a negative charge and the other with a positive. When the objects are separated, they retain the charge imbalance. Objects that have a positive or negative charge will attempt to become neutral again. The excess charge will flow to another object, known as an electrostatic discharge. ”FIG. 12.

The intended effect in our application is opposite as used today in automotive painting where the paint particles are charged, and the car body has an opposite polarity thereby creating less overspray and a higher quality application due to the paint particles further atomizing. In the universal version we call this the U3s. Using an electrode, the pressurized air is charged with the same polarity as the user visor. The air particles then charge the overspray particles, thereby producing a repelling effect when in proximity of the visor. In addition, an electrode can be similarly introduced into the chemical fluid path prior to the fluid leaving the spray foam gun, FIG. 15.

The device may be 3D printed or molded. In the universal design, it is important that the form, fit and function of the respirator are not impacted.

“Air Knives are highly effective for cleaning, drying, blow-off and liquid control for a wide range of industrial applications, Air Knives are designed to ensure a perfectly optimized air flow for a range of industrial applications.”

The effectiveness of Air Knives is achieved through precision engineering and design—Air Knives are engineered to produce a curtain-like flow of air, here referred to as the “air curtain method, (ACM)”, that not only covers the full shape of an object but acts as a barrier to foreign matter as well.

An industrial Air Knife is a pressurized air plenum chamber, FIG. 5, with one or more slots through which pressurized air exits in a laminar (uniform) flow pattern. The exit air velocity creates an impact air velocity onto the surface of products that the air is directed toward.

“Air Knives most commonly consist of a structure, usually made from aluminum, steel or plastic, that houses a plenum chamber and includes a unique shape on one side, formed from two blades joined together, in the shape of a knife-edge. The success of Air Knives comes from their ability to produce the highest force/air consumption ratio. Air Knives can perform cleaning, drying and blow-off functions by emitting a powerful and consistent stream of air. This is achieved through the series of slots that each Air Knife bas along its knife edge. Air Knives incorporate a pressurized container that houses air at a positive pressure-the plenum chamber.”

The benefit of the plenum chamber is that it equalizes pressure, meaning air can be ejected at an even distribution.

The success of Air Knives comes from their ability to produce a particular type of air flow. This design means that when air is ejected through the Air Knife slots, it forms a laminar air flow (that sometimes also displays the Coandă effect). Laminar air flow is a unique and useful type of air movement. It occurs when air moves at the same speed and in the same direction, with no crossover. It is a highly effective barrier and is used for example on research facilities where a sterile environment needs to be maintained. “The Coandă effect is the phenomena where a fluid jet attaches itself to the surface and stays attached even if the surface curves away from the source of the jet. It is a phenomenon which has contributed to the understanding of how an aircraft wing can produce lift. Air Knives therefore sometimes use both laminar flow and the Coandă effect to create an air flow that follows the lines of the objects that pass through it. The laminar air flow generated by Air Knives is created through the inclusion of a plenum chamber at its core. FIG. 5. The plenum chamber is located within the body of the Air Knife and acts as a pressurized container to house the air that is generated by the blower. The plenum chamber equalizes pressure, therefore ensuring even distribution, and therefore laminar air flow, when the air is ejected.”

Another method for shielding the visor is taking a different approach which is to direct air flow in the opposite direction of the anticipated overspray trajectory direction. We call this the “air shield method, (ASM.)” With this method, the forced air is projected not as a curtain, but as a shield like one created by an air fan with “propeller” blades.

To further enhance the invention, we look toward IPC (integrated pneumatic control.) IPC allows for pulsating of the air flow to optimize the deterrence of the media particles. The IPC system also detects when the spray gun is not working and deactivates the Q-Flow shortly after, thereby not wasting air consumption if the user is on break for some time and therefore not working. IPC can function using full pneumatic logic components, and/or electrical components such as a solenoid valve for the pulsation function.

The laminar flow device, according to the present invention, provides a simple and efficient solution to improve respiratory protection visibility efficacy. In the universal version, the invention further provides the additional advantage of being universally applicable across all common mask designs without requiring any additional adapter design. It is also important to note that while the Coanda effect is a powerful concept, it does not lend itself to all Q-Flow designs.

Similar results are achieved where the FFBA functions in other environments than SPF, such as applying paint, powder coating, polyurea, adhesives, etc, which can cause buildup of debris and contaminate the transparent field of view of the workers and/or sensors.

While embodiments and details have been described, it will be appreciated by those skilled in the art that various amendments and modifications can be made without departing from the scope and spirit of the invention as described above. Therefore, the invention is only limited by the appended claims and their equivalents.

### ONE EXAMPLE OF INTENDED USE

Indented use is for the sprayer on each spray foam rig to use a respirator with the functionality of the Q-Flow air foil or Ui light device. Using the Q-Flow air foil or Ui light device allows the sprayer to work safer, to perform a higher quality job and to improve their performance.

1. A custom air-foil system for full face respirators, hoods, helmets comprising:
a) Integrated device body with functionality of reducing debris, media, overspray build-up onto visor, intended for work applications involving spraying, blowing, or projecting chemical material(s) to a surface or to an object.
b) Integrated air knife with use of pressurized air or gas projected with velocity across, or in proximity to surface of visor, where thereby the debris, media, overspray resulting from work, is effectively and efficiently diverted by the air/gas into a different direction than toward visor, essentially acting as a barrier.
c) An air/gas port allowing for connection to a pressurized source.

2. The system described in claim 1 with an integrated pulse control system to maximize efficiency and effectiveness, known as IPC (intelligent pneumatic control.)

3. The system described in claim 1 with integrated lighting, such as LED's, COB, wiring, and optional internal power source, with designed angular lighting direction for maximum POU efficiency.

4. The system described in claim 1 with an electro-static function where the air particles are charged with a like polarity as the visor, further repelling the overspray from the visor.

5. The system described in claim 1 with an integrated sensor capable of detecting proper respirator seal to the user face and tell-tale indication to user when seal is broken.

6. The system described in claim 1 with an integrated RADS (release agent dispensing system) allowing for timed or manual trigger efficient dispensing of foam release agent onto the visor surface.

7. The system described in claim 1 with integrated HUD for displaying user helpful information such as health vitals, machine data, job data, and environment data, where the components (engine, comm. Board, antenna) are located within same shell or are connected using a cable, and a Ud mobile application running on a portable computer.

8. The system described in claim 7 with an integrated laser temperature measurement (LTM) and data input to HUD.

9. A universal design air-foil system for full face respirators, hoods, helmets comprising:
a) Snap-on, stick-on device body with functionality of reducing debris, media, overspray build-up onto visor, intended for work applications involving spraying, blowing, or projecting chemical material(s) to a surface or to an object.
b) Integrated air knife with use of pressurized air or gas projected with velocity across, or in proximity to surface of visor, where thereby the debris, media, overspray resulting from work, is effectively and efficiently diverted by the air/gas into a different direction than toward visor, essentially acting as a barrier.
c) An air/gas port allowing for connection to a pressurized source.
d) Device shell and components designed specifically to not alter form, fit, or function of existing respirator design.

10. The system described in claim 9 with an integrated pulse control system to maximize efficiency and effectiveness, known as IPC (intelligent pneumatic control.)

11. The system described in claim 9 with integrated lighting, such as LED's, COB, wiring, and optional internal power source, with designed angular lighting direction for maximum POU efficiency.

12. The system described in claim 9 with an electro-static function where the air particles are charged with a like polarity as the visor, further repelling the overspray from the visor.

13. The system described in claim 9 with an integrated sensor capable of detecting proper respirator seal to the user face and tell-tale indication to user when seal is broken.

14. The system described in claim 9 with an integrated RADS (release agent dispensing system) allowing for timed or manual trigger efficient dispensing of foam release agent onto the visor.

15. The system described in claim 9 with integrated HUD for displaying user helpful information such as vitals, machine data, job data, and environment data, where the components (engine, comm. Board, antenna) are located within same shell or connected using a cable, and a Ud mobile application running on a portable computer.

16. The system described in claim 15 with an integrated laser temperature measurement (LTM) and data output to HUD.

17. A directed lighting system for full-face respirators, hoods, helmets comprising:
a. A device with functionality of providing supplemental lighting to user in a work environment.
b. Integrated defined color LED and diffusion designed to accentuate the features important to the user in their specific work application.
c. Integrated power source for the LED and electronics PCB (printed circuit board.)

18. The system described in claim 17 where the lighting steps down to a conservative setting to preserve battery life when a specific battery level is reached, referred to as MLD (managed light diminishing.)

19. The system described in claim 17 with an integrated sensor capable of detecting proper respirator seal to the user face, SID (seal integrity detection) and TTI (tell-tale indication) to user when seal is broken.

20. The system described in claim 17 where when the system is located internal to the visor, LED(s) and other electronics are powered through the visor plastic using wireless technology (WPS) consisting of an interior and an exterior component where the exterior component is connected to a power source such as a battery or continuous supply.
